(19) United States
(12) Patent Application Publication
(10) Pub. No.: US 2006/0182775 A1
(43) Pub. Date: Aug. 17, 2006

(54) Insect repellent

(76) Inventor: Jacqui Everett, N. Hollywood, CA (US)

Correspondence Address: MILDE & HOFFBERG, LLP, 10 BANK STREET, SUITE 460, WHITE PLAINS, NY, 10606, US

(21) Appl. No.: 11/355,862

(22) Filed: Feb. 16, 2006

Related U.S. Application Data
(60) Provisional application No. 60/653,388, filed on Feb. 16, 2005.

(51) Int. Cl. A01N 65/00

(52) U.S. Cl. 424/405; 424/742; 424/744; 424/745; 424/736; 424/769; 424/770

(57) ABSTRACT

An insect repelling composition comprising a mixture of oils in desired amounts, by volume: 1) Lemon oil—as a purifier, in the range of 0-30%; 2) Lavender oil or “Lavendine”—as an anti-bacterial agent, which encourages healing, and for fragrance, in the range of 0-10%; 3) Geranium oil—as an antiseptic and for fragrance, in the range of 0-10%; 4) Cedar wood oil—as an insect repellent, in the range of 0-10%; 5) Tea tree oil—as an antifungal agent and antiseptic, and for its healing properties, in the range of 0-15%; 6) Eucalyptus oil—as a natural inflammatory, antiseptic, and repellent, in the range of 0-30%; 7) Aloe vera—as an emulsifier, and its healing properties, in the range of 0-30%.

### REFERENCE TO RELATED APPLICATION

This application claims priority from the U.S. provisional application No. 60/653,388 filed Feb. 16, 2005, and entitled “Insect Repellent”.

### BACKGROUND OF THE INVENTION

The present invention relates to an effective, all-natural, biodegradable, insect repellent, which is non-toxic, pleasant smelling, and has healing properties when applied to the skin. This formula is comprised of six different, all natural, essential oils. The purpose of these oils is to safe-guard the skin; and to give those who prefer an all natural alternative to the chemical preparations that are on the market today the ability to do so. Although these oils are blended in different percentages, together they form a superb synergy. The rare blend of pure oils serve to protect you, and enhance your time while out-doors, and when used in-doors, the fragrance is very pleasing and long lasting.

Biting insects pose a significant problem not only because of the annoyance from their bites and stings, but also because of the potential health risks due to the transmission of diseases from these bites. In light of this, there is significant demand for effective insect repellents. Ideally, an insect repellent should be safe to use on all age groups and most importantly, non-toxic.

The majority of the insect repellents currently available contain a chemical n,n-diethyl-m-toluamide (DEET) as the repelling agent or active ingredient. DEET is readily absorbed through the skin and enters into the blood stream. As a result, it has been shown to adversely affect the nervous system. Specifically, DEET has caused seizures and even death in some individuals. As a consequence, several state public health departments have issued warnings about the possible hazards of overzealous application of products containing DEET. Also, the United States Military now recommends use of repellents with less than 33% DEET. In addition, the American Academy of Pediatrics recommends that repellents used on children contain no more than 10% DEET.

Insect repellents containing DEET are also not recommended for use over cuts, wounds or irritated skin, or next to the eyes or mouth. They are also not recommended for infants and. toddlers as well as on acetate, rayon, spandex, dynel and other synthetic clothes, furniture, plastic, watch crystals, leather and painted and washable surfaces including automobiles. It is therefore quite clear that a safer alternative is needed.

One alternative is citronella oil, which is known to have insect repelling properties. Currently, citronella oil is used as an insect repellent primarily in candles and adhesive patches. As an example, Canadian Patent Application 2,147,595 teaches an adhesive patch comprising 99.9% citronella oil for repelling insects and 0.1% lemongrass oil or spearmint oil to impart fragrance, thereby making the mixture non-offensive to humans. While some creams and lotions containing citronella oil are commercially available, citronella oil caused burning and/or irritation when applied to the facial area of test subjects in our experiments.

U.S. Pat. No. 5,364,626 teaches a composition containing lemon oil for use in repelling animals such as dogs or cats. However, this patent does not envision the use of lemon oil as an insect repellent.

U.S. Pat. No. 5,776,478 teaches a composition containing certain plant extracts for repelling insects. In particular, this patent discloses the use of an active insect repelling ingredient selected from the group consisting of lemon oil, cedar wood oil, and mixtures thereof. An antioxidant is also provided to stabilize the active ingredient. A mixture of ascorbic acid and citric acid, particularly natural sources of these ingredients such as lime juice and lemon juice, is disclosed as the preferred antioxidant.

U.S. Pat. No. 6,749,861 discloses an insect repellant comprising a low vapor pressure repellant such as DEET, DBP and DMP, and a high vapor pressure compound which acts as a solvent for the low pressure repellant. The high vapor pressure compound preferably includes a fragrance selected from the group consisting of salicylates, benzoates, lemon oil, orange oil, citronella oil, geraniol, terpineol, garlic oil, grapefruit oil, mints, southernwood and tee tree oil, lone or in any combination.

### SUMMARY OF THE INVENTION

A principal object of the present invention is to provide an improved insect repellant which is effective, all-natural, biodegradable, non-toxic, pleasant smelling, and has healing properties when applied to the skin.

This object, as well as further objects which will become apparent from the discussion that follows, is achieved, in accordance with the present invention, by providing an insect repelling composition comprising a mixture of three or more of the following oils in the following amounts, by volume:

1) Lemon oil or “Lavendine”—As a purifier and as a base material; in the range of 0% to approximately 30%.

2) Lavender oil—As an anti-bacterial, which encourages healing, and as a fragrance enhancer; in the range of 0% to approximately 10%.

3) Geranium oil—As an antiseptic, and as a fragrance enhancer; in the range of 0% to approximately 10%.

4) Cedar wood oil—As an insect repellent; in the range of 0% to approximately 10%.

5) Tea tree oil—As an antifungal and anti-bacterial, and for its healing properties; in the range of 0% to approximately 15%.

6) Eucalyptus oil—As an insect repellent, a natural anti-inflammatory, and an antiseptic; in the range of 0% to approximately 30%.

Aloe Vera can also be added for its healing properties and as an emulsifier to keep the other oils in the liquid from separating. Its percentage may be in the range of 0% to 30% by volume, depending upon whether the insect repellant is an oil, a lotion or a cream.

Lemon oil and Eucalyptus oil may be introduced into the composition separately. However when combined, they form a more effective component: Lemon/Eucalyptus (“Citriadora”). Often when the essential oil is extracted from the natural plant, for example by cold pressing, steam distilling, or by CO2 extraction, many needed and important components can be lost which makes the particular essential oil weaker as an insect repellant. These extra components may be re-captured or separately manufactured, and then reintroduced as an extra component to strengthen the essential oil, thus restoring the efficacy of the essential oil to its original form. In the case of Lemon/Eucalyptus, the component “PMD”, or Menthol-Glycol, is manufactured separately and introduced into the formula to give the composition greater efficacy, thus a longer lasting repellency per each application.

Each oil in the composition has a specific purpose within the formula. The percentages are selected by trial and error, up or down, depending upon the degree of repellency needed for each type of insect, and depending upon the other qualities desired. The objective is to provide the most effective, natural insect repellant possible for fleas, ticks and/or mosquitoes which is nevertheless safe and, if possible, also therapeutic for the skin. The pure natural oils are very strong by themselves and can burn the skin; therefore, they must be diluted with a base substance. It is also desirable, but not necessary, to include one or more of the fragrance oils to impart a pleasant smell to the composition. It has been found that the ingredients listed above combine and work particularly well together to achieve this objective.

In a repellant designed for children, in lotion form, the percentages may change because lotion as a base liquid (or foundation liquid) is more dense, and may need more oils to create the repellency needed. In an insect repellent designed for animals, in oil form, the percentages may change because animals are outdoors more often, and a more sensitive blend may be needed to produce the desired repellency. The oils may remain the same, but the percentage of each oil may change. These changes in percentages serve to tailor the formula to the particular use.

Each oil, individually, makes up a percentage of the total amount of oil, by volume, used in the formula. Each oil is mixed into the composition to arrive at a total volume of 100%. The formula is mixed by hand or machine, and poured into labeled plastic or aluminum bottles, in a designated manufacturing facility. Tubes may also be used. This formula can also be made into a light cream and an all natural lotion that can be put into tubes, plastic, or aluminum bottles. The formula can be sprayed or rubbed on.

The oils can be extracted from the natural plant by being:

1) Steam distilled;

2) CO2 extracted; or

3) Cold pressed.

Vitamin E, or C in liquid form, may be added as an antioxidant and an oil preserver. Sesame oil may be added for (SPF) sun protection.

In addition, the insect repellant may comprise one or more of a base made of Jojoba oil, or alternatively wheat germ oil, a repellent made of lemon grass oil, a taste component of pennyroyal oil, a healing component of tea tree oil and a moth repelling component of white cedar oil, each in their desired amounts by volume.

The insect repellent is formulated to deter fleas and ticks as well as mosquitoes. These three insects are especially important because fleas, ticks, and mosquitoes carry potentially fatal diseases such as Limes disease. Limes disease is known to cause organ damage, swelling, and joint problems. Mosquitoes can also carry the West Nile virus, among other diseases, which is often fatal.

It is well known that insects respond to taste and smell. The repellent has both an unwanted taste and smell and insects are repelled by it. The purpose of an insect repellent is to address the dislikes of the insects. That is why the oils in this formula are so carefully selected; together they form a blend that is therapeutic, pleasant smelling, and naturally repelling. Insects will not fly around, crawl on, latch on to, sting, or bite the area that has the repellent rubbed or sprayed on to it. In addition, the tea tree oil will heal any pre-existing bites, or old wounds.

The repellent can be sprayed in any living environment: i.e., offices, homes, barns, stalls, greenhouses etc. It is environmentally friendly. Trees, shrubs, lawns, and houseplants can be sprayed to save fruit, birds, flowers, and vegetables. Farm animals can also benefit from an application of the repellent.

The insect repellent according to the invention has been tested on a 4-month old baby, a 5 year-old child, the elderly, many adults, and many dogs and horses, all without adverse effects. A dog sprayed with the repellent has not had a flea or tick in 2 years. The children were not bitten by any mosquitoes. The elderly and very young children cannot use existing insect repellents that are on the market today because they cannot throw off the poison which kills the insects. The body of a child is too under-developed; and that of the elderly is too infirmed.

The insect repellent according to the invention uses only natural ingredients, thus providing a chance to rid the earth of chemical poisons that are harming the environment.

There has thus been shown and described a novel insect repellent which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. An insect repelling composition for external application comprising at least three oils selected from the group consisting of lemon, lavender, eucalyptus, geranium, cedar wood, tea tree and aloe vera.

2. The composition defined in claim 1, wherein the lemon oil is in the range of 0 to 30% by volume.

3. The composition defined in claim 1, wherein the lavender oil is in the range of 0 to 10% by volume.

4. The composition defined in claim 1, wherein the geranium oil is in the range of 0 to 10% by volume.

5. The composition defined in claim 1, wherein the cedar wood oil is in the range of 0 to 10% by volume.

6. The composition defined in claim 1, wherein the tee tree oil is in the range of 0 to 15% by volume.

7. The composition defined in claim 1, wherein the eucalyptus oil is in the range of 0 to 30% by volume.

8. The composition defined in claim 1, wherein the aloe vera is in the range of 0 to 30% by volume.

9. The composition defined in claim 1, further comprising sesame oil.

10. The composition defined in claim 1, further comprising a vitamin selected from the group consisting of vitamin C and E, in liquid form.

11. The composition defined in claim 1, further comprising Jojoba oil.

12. The composition defined in claim 1, further comprising wheat germ oil.

13. The composition defined in claim 1, further comprising lemon grass oil.

14. The composition defined in claim 1, further comprising pennyroyal oil.

15. The composition defined in claim 1, further comprising white cedar oil.
